(19) United States
(12) Patent Application Publication
(10) Pub. No.: US 2011/0293428 A1
(43) Pub. Date: Dec. 1, 2011

(54) METHOD FOR OPTIMIZING THE CONTACT SURFACES OF SHROUD SEGMENTS, WHICH ABUT AGAINST ONE ANOTHER, OF ADJACENT BLADES OF A GAS TURBINE

(75) Inventors: Igor Tsypkaykin, Turgi (CH); Andre Saxer, Mellingen (CH)

(73) Assignee: ALSTOM TECHNOLOGY LTD, Baden (CH)

(21) Appl. No.: 13/117,166

(22) Filed: May 27, 2011

Related U.S. Application Data
(63) Continuation of application No. PCT/EP2009/065543, filed on Nov. 20, 2009.

(30) Foreign Application Priority Data
Nov. 27, 2008 (CH) 01854/08

(51) Int. Cl. F01D 5/22; G06F 17/50

(52) U.S. Cl. 416/179; 703/1

(57) ABSTRACT

A method for optimizing the contact surfaces of abutting shroud segments of adjacent blades of a rotor blade row of a gas turbine includes providing a 3-D model of an individual blade. A geometry of the individual blade is calculated using the 3-D model while considering centrifugal forces, temperature stresses and pressure loads experienced in a loaded state of the blade during operation. The contact surfaces of the abutting shroud segments of adjacent blades are optimized in the loaded state of the blade. The optimization includes the surfaces of functionally serving interlocking surfaces and functionally serving wedge surfaces disposed on each side of the interlocking surfaces. A geometry of the interlocking surfaces and of the wedge surfaces in an unloaded state corresponding to the optimized contact surfaces in the loaded state of the blade is calculated.

### CROSS REFERENCE TO RELATED APPLICATIONS

This application claims priority from International Patent Application No. PCT/EP2009/065543, filed Nov. 20, 2009, which claims priority from Swiss Patent Application No. 01854/08, filed Nov. 27, 2008, each of which are incorporated by reference herein in their entireties. The International Application was published on Jun. 3, 2010 as WO/2010/060867.

### FIELD

The present invention relates to the field of gas turbines and a method for optimizing the contact surfaces between the interlocking surfaces of the abutting shroud segments of adjacent blades of a rotor blade row of a gas turbine.

### BACKGROUND

The rotor blades of gas turbines are exposed to powerful centrifugal forces, high temperatures and high pressures during operation. This load, which can consist of expansion, tilting and twisting, leads to a deformation in the blades. The alteration of the blade geometry can be considerable especially in the case of long blades. It particularly has repercussions in the case of rotor blades which are equipped with a shroud segment on the blade tip in each case. The shroud segments of adjacent blades of a blade row inter-engage or abut and form an annular shroud which on the outside encompasses the hot gas passage of the gas turbine and is sealed to the outside.

The shroud segments on the one hand are to abut tightly so that no hot gas from the hot gas passage can penetrate into the mostly cooled cavity which is formed outside the shroud. On the other hand, the shroud segments should be prevented from building up large pressure stresses on narrowly delimited contact surfaces on account of operation-induced deformations of the blade, which can lead to plastic deformation and/or to creeping of the blade material and/or to fusing of the blades themselves. As a result of this, the service life of the blades is significantly reduced or removal of the blades for maintenance purposes is hindered.

The problem of operation-induced blade deformation is mentioned in printed publication EP-A1-1 591 625. In order to reduce the deformation in the region of the shroud segments, it is proposed there to reinforce and to stiffen the shroud segments by means of bars provided on the sides.

Reinforcements of this type certainly effectively limit deformation in the shroud segment itself, but are largely ineffective against other deformations of the blade, such as twisting around the longitudinal axis.

### SUMMARY OF THE INVENTION

An aspect of the present invention is to provide a method for producing a gas turbine rotor blade, by means of which the contact surfaces between the interlocking surfaces of the abutting shroud segments of adjacent blades of a rotor blade row can be optimized to the effect that narrowly delimited contact surfaces with high pressure stresses can be reliably avoided without forfeiting the necessary sealing tightness between the adjacent shroud segments.

In an embodiment, the present invention provides a method for optimizing the contact surfaces of abutting shroud segments of adjacent blades of a rotor blade row of a gas turbine. A 3-D model of an individual blade is provided. A geometry of the individual blade is calculated using the 3-D model while considering centrifugal forces, temperature stresses and pressure loads experienced in a loaded state of the blade during operation. The contact surfaces of the abutting shroud segments of adjacent blades are optimized in the loaded state of the blade. The optimization includes the surfaces of functionally serving interlocking surfaces and functionally serving wedge surfaces disposed on each side of the interlocking surfaces. A geometry of the interlocking surfaces and of the wedge surfaces in an unloaded state corresponding to the optimized contact surfaces in the loaded state of the blade is calculated.

### BRIEF DESCRIPTION OF THE DRAWINGS

The invention shall subsequently be explained in more detail based on exemplary embodiments in conjunction with the drawings. Certain elements which are not required for the direct understanding of the invention have been omitted. Like elements are provided with the same designations in the different figures. In the drawings:

FIG. 1 shows in a side view a (long) rotor blade of a gas turbine with shroud segment at the blade tip, as is suitable for application of the invention;

FIG. 2 shows in plan view from above in the direction of the blade longitudinal axis two adjacent blades of the type shown in FIG. 1, with the inter-engaging interlocking surfaces of their shroud segments;

FIG. 3 shows in a detail the section through the oppositely-disposed edges of adjacent shroud segments with the interlocking surfaces; and

FIG. 4 shows different steps during optimization of the contact surfaces of the shroud segments according to an exemplary embodiment of the invention.

### DETAILED DESCRIPTION

The calculation taken as a basis under b) can also be dependent from case to case upon additional parameters in relation to the parameters focused upon here, for example upon the respective material used for the blade, upon the respective type of manufacture of the blade, and upon the respective additional modifying processes to which the blade is subjected. In such cases, the corresponding parameters are incorporated for calculation of the geometry.

The invention is based on the knowledge that it is not sufficient to equip the shroud segments in the unloaded state with interlocking surfaces which are parallel to each other in order to maintain contact over a large area between the adjacent shroud segments in the loaded state. Rather, the deformation of the blade on account of the operation-induced loads should be incorporated in the design of the (unloaded) blade so that with the deformation an approximate parallelization of the interlocking surfaces is first achieved, which at the same time ensures satisfactory sealing tightness and distribution over a large area of possible pressure stresses between the segments.

The deformation behavior of the respective blade is calculated on the basis of a 3D-model of the blade for this purpose, so that it can be predetermined by computer which configuration (geometry) of the shroud segments in the unloaded state of the blade results in the desired configuration (geometry) of the shroud segments in the loaded state of the blade. If this (optimized) initial configuration (with possibly non-parallel interlocking surfaces) is determined from the model calculation, it can be taken into account when producing the blade, for example when designing the casting mold. The current shape of the interlocking surfaces in this case depends significantly upon the deformation behavior of the respective blade, which is influenced inter alia by the wall thicknesses, the blade length, the shape of the blade airfoil and the operating location of the respective blade in combination with the adjacent blades.

The contact surfaces between the interlocking surfaces of the abutting shroud segments of adjacent blades in the loaded state of the blade are preferably optimized to the effect that an increase of the contact pressure as a result of the heating up of the blade at operating temperature is avoided.

However, it is also alternatively or additionally intended, depending upon requirement, to optimize the contact surfaces between the interlocking surfaces of the abutting shroud segments of adjacent blades in the loaded state of the blade to the effect that a drop of the natural frequency of the blade as a result of the heating up of the blade at operating temperature is avoided.

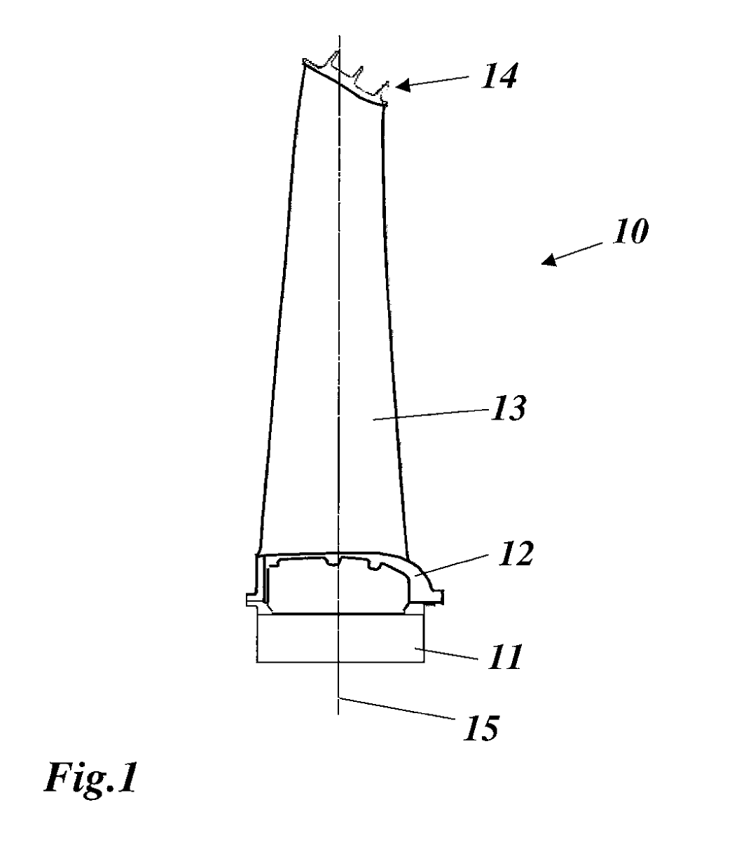

In FIG. 1, a (relatively long) rotor blade, as is suitable for the application of the invention, is shown in a side view. The blade 10 extends in its longitudinal direction (radial direction inside the gas turbine) along a longitudinal axis 15 and comprises a blade root 11 for fastening the blade on the rotor, a platform 12 which forms the inner limit of the hot gas passage, a blade airfoil 13, and a shroud segment 14 which is arranged at the blade tip.

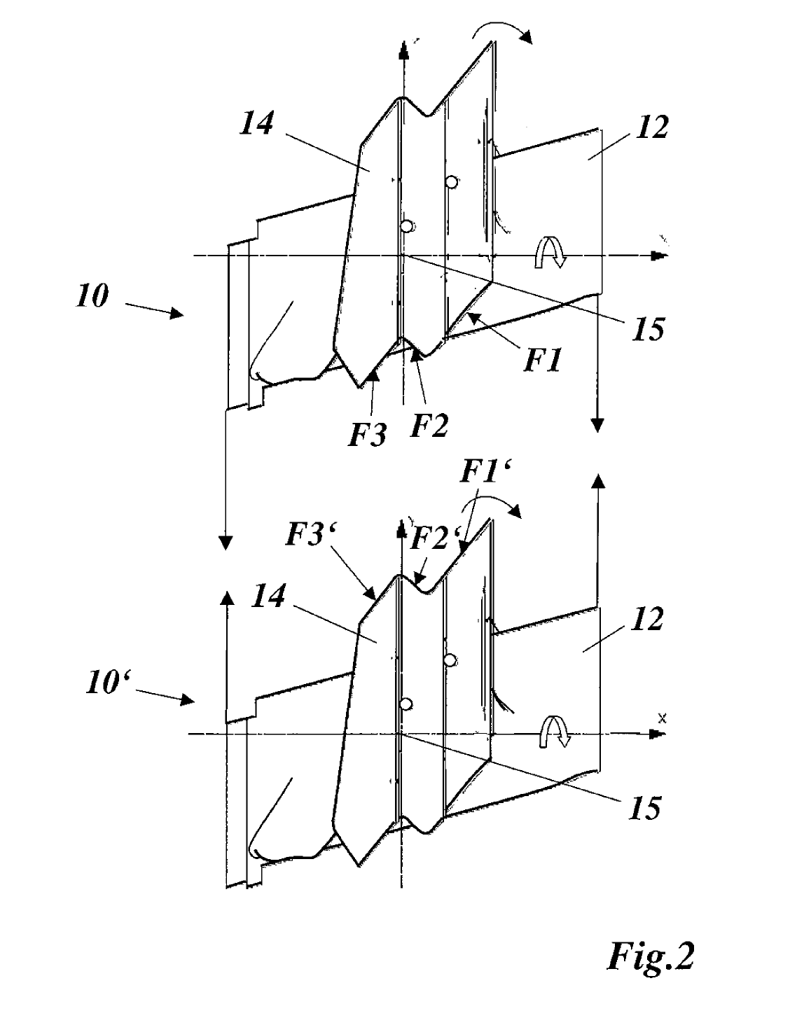

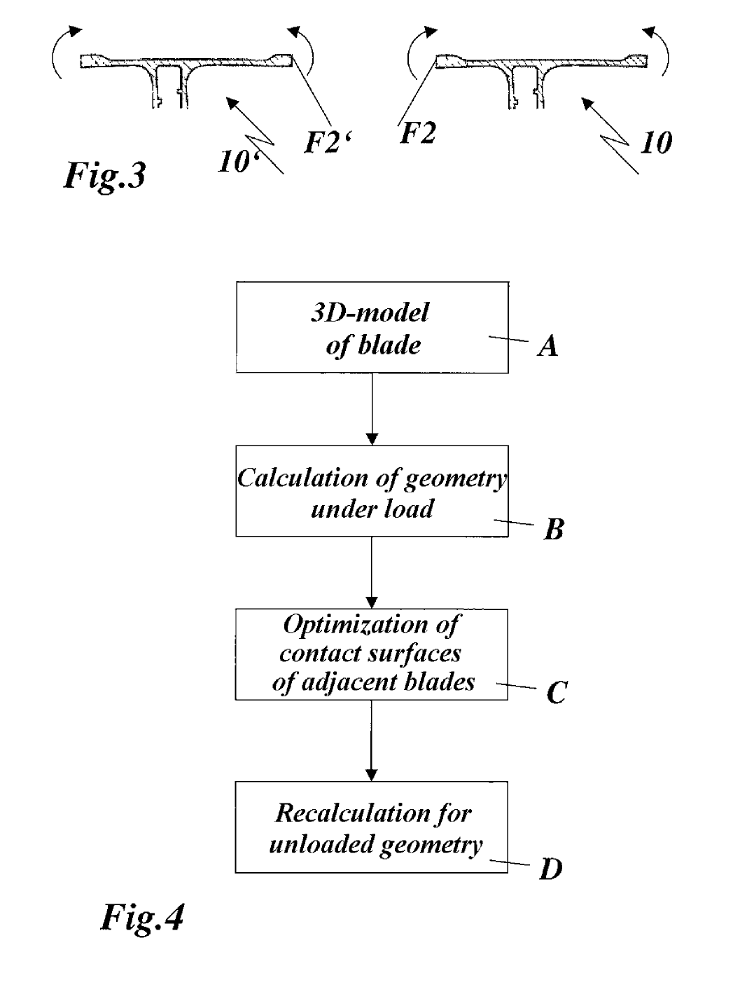

In plan view in the radial direction (in the direction of the longitudinal axis 15), the shroud segment 14 has the edge contour, for example, which is shown in FIG. 2. In the circumferential direction (y-direction in FIG. 2), the shroud segment 14 of FIG. 2 is delimited by wedge surfaces F1 and F3 or F1′ and F3′ which are arranged in a zigzag manner, and also by interlocking surfaces F2 and F2′ which are arranged in between. If two adjacent blades 10 and 10′ are moved towards each other in the direction of the arrows in FIG. 2 (y-direction) or of the arrows according to FIG. 3, the two shroud segments 14 inter-engage by the interlocking surfaces F2 and F2′, wherein the opposed wedge surfaces F1, F1′ or F3, F3′ which are arranged on both sides of the interlocking surfaces F2, F2′ undertake a stabilizing guiding function.

In conventional constructions, the interlocking surfaces F2, F2′ were previously aligned parallel to each other in pairs during production of the blades 10, 10′. If, during operation, the blades 10, 10′ are then twisted around the longitudinal axis 15, for example, in the direction of the rotational arrows which are drawn in FIG. 2, and if the interlocking surfaces F2, F2′ are no longer parallel in pairs but strictly localized contact regions with high pressure stress are created, on which the shroud segments 14 abut, this can partially also then lead to plastic deformations during operation, wherein it cannot be excluded either that even local fusions then occur.

According to embodiments of the invention, the blade is now described by means of a 3D-model which enables a calculation of the geometry which is altered under load (steps A and B in FIG. 4). For the altered geometry, the adjoining surfaces can now be selected so that the undesired strictly localized contact regions between the adjacent shroud segments are avoided without the sealing tightness between the shroud segments being excessively impaired (step C in FIG. 4). If the shroud segments 14 in the loaded state are correspondingly configured, the corresponding configuration in the unloaded state can be referred back to on account of the 3D-model (step D in FIG. 4). This corresponding configuration is then used for producing the blade 10 or 10′.

### LIST OF DESIGNATIONS

10, 10′ Blade (gas turbine)

11 Blade root

12 Platform

13 Blade airfoil

14 Shroud segment

15 Longitudinal axis (blade)

F1, F1′ Wedge surface

F2, F2′ Interlocking surface

F3, F3′ Wedge surface

What is claimed is:

1. A method for optimizing the contact surfaces of abutting shroud segments of adjacent blades of a rotor blade row of a gas turbine, the method comprising the steps of:
a) providing a 3-D model of an individual blade;
b) calculating a geometry of the individual blade using the 3-D model, the calculating including consideration of centrifugal forces, temperature stresses and pressure loads experienced in a loaded state of the blade during operation;
c) optimizing the contact surfaces of the abutting shroud segments of adjacent blades in the loaded state of the blade, including functionally serving interlocking surfaces and functionally serving wedge surfaces disposed on each side of the interlocking surfaces; and
d) determining a geometry of the interlocking surfaces and of the wedge surfaces in an unloaded state corresponding to the optimized contact surfaces in the loaded state of the blade.

2. The method recited in claim 1, wherein the contact surfaces between the interlocking surfaces of abutting shroud segments of adjacent blades in the loaded state of the blade are optimized so as to avoid an increase in contact pressure as a result of ensuing operating temperature of the blades.

3. The method recited in claim 1, wherein the contact surfaces between the interlocking surfaces of abutting shroud segments of adjacent blades in the loaded state of the blade are optimized so as to avoid a drop in a natural frequency of the blade as a result of ensuing operating temperature of the blades.

4. The method recited in claim 2, wherein the contact surfaces between the interlocking surfaces of abutting shroud segments of adjacent blades in the loaded state of the blade are optimized so as to avoid a drop in a natural frequency of the blade as a result of ensuing operating temperature of the blades.

5. A blade for a rotor blade row of a gas turbine, the blade comprising:
a shroud segment including contact surfaces configured to abut shroud segments of adjacent blades, the contact surfaces including
a functionally serving interlocking surface including sides; and
functionally serving wedge surfaces disposed on both sides of the interlocking surface and in an opposed manner to the interlocking surface, the wedge surfaces being configured to undertake a guiding function.
